(19) United States
(12) Patent Application Publication
(10) Pub. No.: US 2026/0046432 A1
(43) Pub. Date: Feb. 12, 2026

(54) Method and Apparatus for Video Coding with Hardware Accelerator via Shared Memory

(71) Applicant: MEDIATEK INC., Hsinchu City (TW)

(72) Inventors: Hong-Hui Chen, Hsinchu City (TW); Yi-Wen Chen, San Jose, CA (US); Tzu-Der Chuang, Hsinchu City (TW); Ching-Teh Chen, Hsinchu City (TW); Chih-Wei Hsu, Hsinchu City (TW); Yu-Wen Huang, Hsinchu City (TW)

(73) Assignee: MEDIATEK INC., Hsinchu City (TW)

(21) Appl. No.: 19/294,316

(22) Filed: Aug. 8, 2025

Related U.S. Application Data
(60) Provisional application No. 63/680,665, filed on Aug. 8, 2024.

(51) Int. Cl. H04N 19/423; G06F 9/50; H04N 19/172

(52) U.S. Cl. CPC H04N 19/423; G06F 9/5027; H04N 19/172

(57) ABSTRACT

A method and apparatus for video coding with hardware accelerator via shared memory are provided. The method includes receiving video data to be processed by a video codec, transferring a portion of the video data from the video codec to a memory accessible by both the video codec and a hardware accelerator, processing the portion of the video data by the hardware accelerator to generate a processed portion of the video data, and encoding or decoding video pictures using the processed portion of the video data from the memory. The hardware accelerator can perform operations including reference picture resampling, loop filtering, motion estimation, or adaptive loop filtering. The memory can include compute-in-memory (CIM) capabilities for performing computational operations such as batch normalization, pooling, down-sampling, data format conversion, or pixel shuffling. The memory architecture can include both CIM channels and non-CIM channels to optimize data processing efficiency.

### CROSS REFERENCE TO RELATED APPLICATIONS

This application claims the benefit of U.S. Provisional Application No. 63/680,665, filed on Aug. 8, 2024. The content of the application is incorporated herein by reference.

### BACKGROUND

Modern video coding systems increasingly rely on specialized hardware accelerators to achieve high performance and energy efficiency. For highly efficient computation, two critical aspects must be fulfilled: parallelism of processing elements and availability of operands through efficient data movement. In practical systems where system memory is accessed by multiple sub-systems, data movement infrastructure is typically designed to maximize average utilization of computation units. To increase data movement efficiency, sub-systems exchange data through shared memory, such as multi-core CPUs using L2 shared cache or integrated CPU-GPU processors.

Currently, machine learning sub-systems such as DPU (deep learning processing unit), NPU (neural processing unit), and AI cores are being integrated into video processing systems, while video compression algorithms increasingly leverage machine learning concepts for high compression ratios and good video quality. However, efficient data exchange between video codecs and these machine learning accelerators remains a significant challenge for next-generation video compression algorithms. Therefore, there is a need for improved methods and apparatus that enable efficient data exchange between video codecs and hardware accelerators, particularly leveraging shared memory architectures and to enhance video coding performance while reducing energy consumption and latency.

### SUMMARY

An embodiment provides a method of video coding for encoding or decoding video pictures comprising receiving video data to be processed by a video codec, transferring a portion of the video data from the video codec to a memory that is accessible by both the video codec and at least one hardware accelerator, processing the portion of the video data by the hardware accelerator to generate a processed portion of the video data, and encoding or decoding the video pictures using the processed portion of the video data from the memory.

In some aspects, the processing operations performed by the hardware accelerator include reference picture resampling, loop filtering, motion estimation, or adaptive loop filtering. Reference picture resampling comprises neural network-based scaling operations for generating upsampled or downsampled reference pictures. In some aspects, the adaptive loop filtering is performed using convolution operations between filter coefficients and pixel data stored in the memory.

In some aspects, the hardware accelerator comprises various types of specialized processing units including a neural processing unit (NPU), graphics processing unit (GPU), artificial intelligence (AI) core, or deep learning processing unit (DPU).

In some aspects, the memory comprises compute-in-memory (CIM) capabilities for performing computational operations directly within the memory interface. An embodiment provides CIM capabilities that perform operations such as batch normalization, pooling, down-sampling, data format conversion, or pixel shuffling. In some aspects, the CIM capabilities assist in motion estimation by executing subtraction operations, multiplication operations, and pooling operations to determine motion vectors.

In some aspects, the memory comprises both CIM channels for computationally intensive data and non-CIM channels for metadata and control information. In some aspects, the processed portion of the video data comprises luma reconstruction data, chroma reconstruction data, or filtered pixel data that is transferred back to the video codec through the memory.

An embodiment provides an apparatus comprising a video codec for receiving and transferring video data, a memory accessible by the video codec for storing the video data, and a hardware accelerator accessible to the memory for processing the video data. In some aspects, the video codec is further used to encode or decode video pictures using the processed data from the hardware accelerator.

In some aspects, the hardware accelerator is used to perform reference picture resampling using neural network-based scaling operations. In some aspects, the hardware accelerator is used to perform adaptive loop filtering using convolution operations between filter coefficients and pixel data stored in the memory.

In some aspects, the memory comprises compute-in-memory (CIM) capabilities for performing computational operations on the video data. In some aspects, the CIM capabilities are for performing batch normalization, pooling, down-sampling, data format conversion, or pixel shuffling operations.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a block diagram of an exemplary apparatus for video coding according to an embodiment.

FIG. 2 depicts the reference picture resampling (RPR) relationship among a current picture and reference pictures in video coding according to an embodiment.

FIG. 3 depicts the architecture of neural network-based super-resolution for reference picture resampling according to an embodiment.

FIG. 4A and FIG. 4B depict two sequential time instances of data exchange between a video codec and hardware accelerator for neural network-based reference picture resampling according to an embodiment.

FIG. 5 depicts the architecture of a neural network-based super-resolution system for directly generating high-resolution reconstruction according to an embodiment.

FIG. 6 depicts a shared memory architecture with both CIM and non-CIM channels between a video codec and hardware accelerator according to an embodiment.

FIG. 7 depicts a flow diagram presenting a method for encoding or decoding video pictures according to an embodiment.

### DETAILED DESCRIPTION

For highly efficient computation to complete all kinds of tasks, two aspects should be fulfilled to achieve the goal. The first aspect is the parallelism of the processing elements. For example, vector addition and vector multiplication operations require multiple arithmetic units to compute when a throughput goal of handling operands is imposed. The second aspect is the availability of the operands, which can also be regarded as data movement of a computation system. For the computation to be executed, the operands involved in the computation should be ready as inputs to the arithmetic units. Ideally, the operands should always be ready for full utilization of the arithmetic units. However, in a practical system, especially when the system memory is accessed by multiple sub-systems, the infrastructure for data movement is normally designed to maximize the average utilization of the computation units of the sub-systems. To further increase the efficiency of data movement, sub-systems are designed to exchange data through shared memory. For example, a multi-core CPU exchanges data among cores through L2 shared cache (which can be viewed as specialized memory). Processors with integrated multi-core CPU and GPU also exchange data through shared memory. In systems where CPU and GPU communicate through a PCI-E bus, all data exchange is completed by the high-speed PCI-E link, which has evolved through several generations to provide constantly increased bandwidth for data movement. Although the speed of the PCI-E link is quite high for data exchange, the energy efficiency for data exchange is not as good as integrated systems, where data are exchanged through internal buses of the chip, and shared memory coupled with these buses can be regarded as a data buffer for smoothing data exchange traffic. A well-known example of the integration of CPU and GPU is APU (Accelerated Processing Unit), where a SoC is designed with CPU and GPU integrated together, and data are exchanged between CPU and GPU through on-chip shared memory.

Currently, a new type of sub-system is being integrated into systems. These sub-systems are related to machine learning. Popular names include DPU (deep learning processing unit), NPU (neural processing unit), and AI (artificial intelligence) core/processor/engine. Meanwhile, algorithm development in video compression leverages machine learning concepts to achieve high compression ratios and maintain good video quality. Efficient data exchange between video codecs (encoder and decoder) and DPU/NPU/AI cores is crucial for implementing next-generation video compression algorithms. Additionally, GPUs can also serve in the role of machine learning acceleration. Therefore, exchanging data between GPUs and video codecs is also important for advanced video compression applications. Furthermore, CPU vendors are starting to add AI acceleration capabilities to their processors. For example, ARM's CPU IP can integrate AI acceleration capabilities through specific CPU instructions or by adding sub-system AI cores. Since ARM's CPU IP can be licensed for customization, methods to enhance the efficiency of data exchange can also be utilized in these situations.

In addition to using shared memory as a data buffering mechanism, recent developments in memory technology that equips computing capabilities inside the memory can be utilized to offload some computation to the memory. This concept is known as compute-in-memory (CIM) or in-memory-compute (IMC).

### 1. Architecture for Exchanging Data Between Video Codec and Accelerators

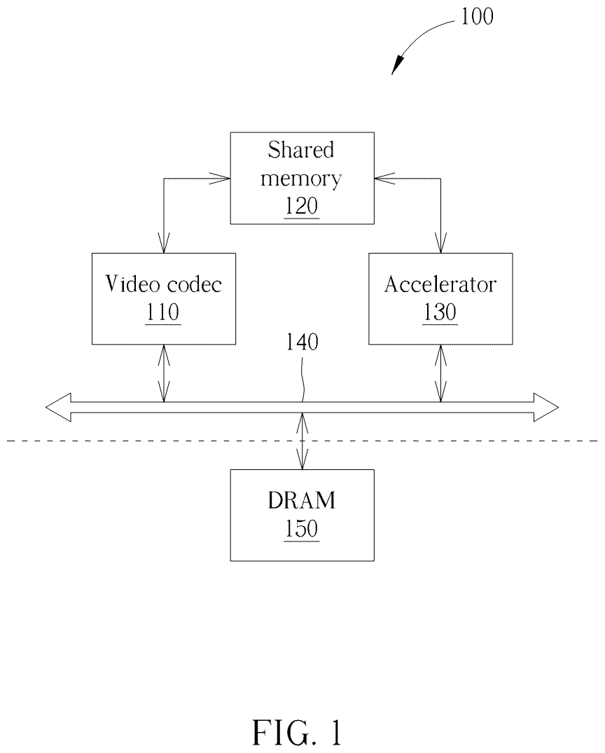

FIG. 1 depicts a block diagram of an exemplary apparatus 100 for video coding according to an embodiment of the present invention. The apparatus 100 comprises a video codec 110, a shared memory 120, and a hardware accelerator 130, all integrated on-chip and coupled to external dynamic random access memory (DRAM) 150 via a bus 140.

The video codec 110 is arranged to process video data for encoding or decoding video pictures. The video codec 110 has bidirectional access to the shared memory 120, allowing it to transfer portions of video data to the shared memory 120 and retrieve processed data from the shared memory 120. The video codec 110 may comprise various functional blocks for video processing including prediction, transform, quantization, entropy coding (for encoding), and corresponding inverse operations (for decoding).

The shared memory 120 serves as an on-chip buffer that is accessible by both the video codec 110 and the hardware accelerator 130. The shared memory 120 is designed to receive and store portions of video data transferred from the video codec 110, and to provide this data to the hardware accelerator 130 for processing. The shared memory 120 eliminates the need for data exchange through the external DRAM 150 for codec-accelerator operations, thereby significantly reducing latency and energy consumption compared to conventional architectures where all data exchange occurs via external memory.

The hardware accelerator 130 represents a specialized processing unit adapted to perform various operations on the video data stored in the shared memory 120. The hardware accelerator 130 may comprise one or more of: a neural processing unit (NPU), a graphics processing unit (GPU), an artificial intelligence (AI) core, a deep learning processing unit (DPU), a central processing unit (CPU), or an accelerated processing unit (APU). The hardware accelerator 130 may be arranged to perform various operations including but not limited to reference picture resampling (RPR), loop filtering, motion estimation, adaptive loop filtering, or neural network-based processing such as super-resolution. The hardware accelerator 130 has bidirectional access to the shared memory 120, enabling it to read input data and write processed results back to the shared memory 120.

The bus 140 provides connectivity between the on-chip components (video codec 110, shared memory 120, hardware accelerator 130) and the external DRAM 150. While the apparatus 100 maintains access to external DRAM 150 for general memory operations, the shared memory 120 architecture allows for efficient data exchange between the video codec 110 and hardware accelerator 130 without requiring access to the external DRAM 150 for every operation.

The dotted line in FIG. 1 represents the boundary between on-chip and off-chip components, emphasizing that the video codec 110, shared memory 120, and hardware accelerator 130 are all integrated on the same chip, while DRAM 150 is external to the chip. In operation, the video codec 110 transfers a portion of video data to the shared memory 120, the hardware accelerator 130 processes this data while it resides in the shared memory 120, and the video codec 110 subsequently uses the processed data from the shared memory 120 to encode or decode video pictures.

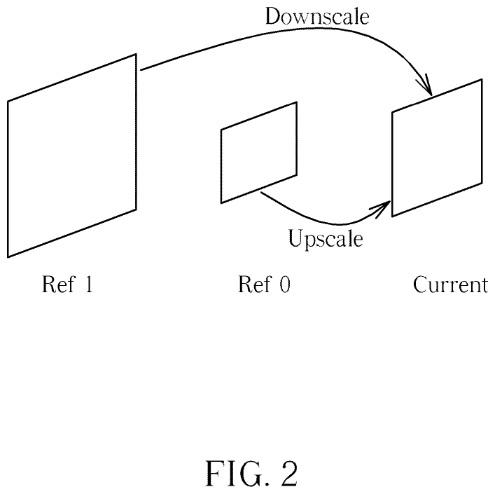

FIG. 2 depicts the reference picture resampling (RPR) relationship among a current picture and reference pictures in video coding according to an embodiment. Three pictures are shown: Reference picture 1 (Ref 1), Reference picture 0 (Ref 0), and the current picture. Each picture is represented as a rectangular frame, with their relative sizes indicating the resolution differences that may necessitate scaling operations for proper motion compensation.

Reference picture 1 (Ref 1) is shown as the largest picture in the sequence. When Ref 1 is used as a reference for motion compensation of the current picture, it may undergo a down-scaling operation as indicated by the “downscale” arrow. This down-scaling can be necessary because Ref 1 has a higher resolution than the current picture. The down-scaling process can reduce the spatial resolution of Ref 1 to match the resolution requirements for motion compensation with the current picture.

Reference picture 0 (Ref 0) is depicted as the smallest picture in the sequence. When Ref 0 is used as a reference for motion compensation of the current picture, it may undergo an up-scaling operation as indicated by the “upscale” arrow. This up-scaling can be required because Ref 0 has a lower resolution than the current picture. The up-scaling process can increase the spatial resolution of Ref 0 to provide appropriate reference samples for motion compensation.

The current picture is shown with an intermediate size between Ref 1 and Ref 0, representing the target resolution for the encoding or decoding process. The current picture serves as the reference point for determining what scaling operations may be needed for the reference pictures.

This RPR mechanism can be particularly useful in video coding scenarios involving zoom-in or zoom-out camera operations, where consecutive frames may have different effective resolutions. Another use case for RPR can be network bandwidth adaptation. When there is a shortage of network bandwidth, encoding the video with RPR enabled and setting a scaling ratio for the current picture to be encoded at lower resolution provides an effective and practical method for overcoming variations in available bandwidth for video transmission. RPR can also be beneficial for adaptive streaming applications where encoding resolution may change dynamically. In H.266/VVC, common scaling ratios may include 1.25, 1.5, and 2.0, with the scaling ratio range extending from ⅛ to 2.0. For example, if scaling ratio is 2.0, a picture with resolution 3840×2160 is converted to 1920×1080 while encoding this picture. For coding with inter slices, coded pictures become the reference pictures for coding current frame. The scaling ratios of the reference pictures can be different from that of the current picture.

In current RPR implementations, the scaling algorithm may employ traditional scaling methods where spatial filtering is applied with different phase offsets of interpolation to generate up-sampled or down-sampled pixel samples. However, this scaling algorithm can be further refined or replaced by a deep neural network to complete the scaling task. By training with large amounts of video data, deep neural networks can show superior performance for picture scaling. Neural network-based (NN-based) super resolution has been proposed in JVET meetings (JVET-AA0065, JVET-AA0071, JVET-AA0076, JVET-AA0084) and has shown good potential for coding gain improvements.

To complete the computation of NN-based super resolution, pixel data may be transferred to a hardware accelerator. With the shared memory architecture of the present invention, the efficiency of data exchange can be greatly improved. Without this shared memory, data would typically be exchanged via external DRAM, which requires significantly more latency and energy consumption-up to orders of magnitude higher compared to exchanging data through shared memory. Therefore, the proposed architecture can provide much greater efficiency for implementing advanced RPR techniques with neural network enhancement.

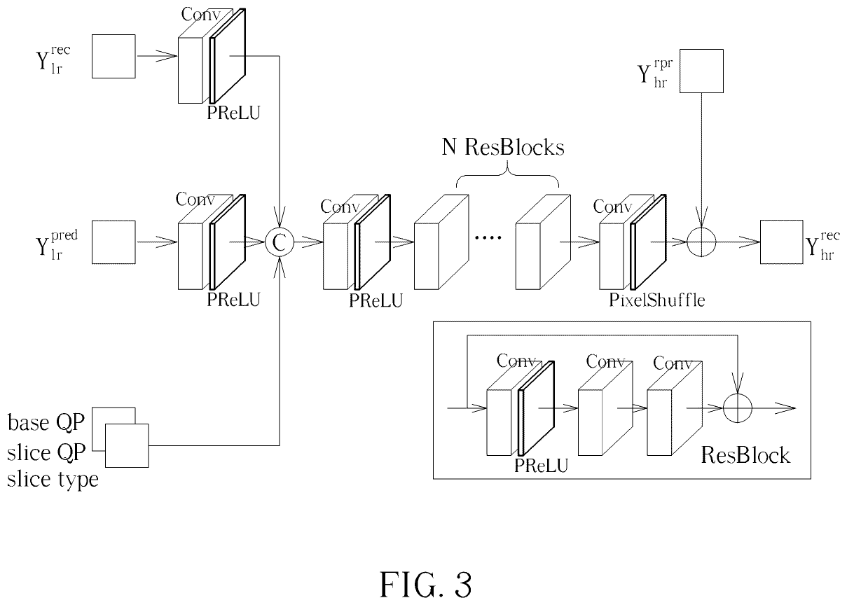

FIG. 3 depicts the architecture of neural network-based super-resolution for reference picture resampling according to an embodiment. The architecture shown in FIG. 3 demonstrates the data flow and processing stages for implementing NN-based super-resolution as an enhancement to traditional RPR methods. The system may process both luma and chroma components through separate but related pathways, utilizing various input parameters to achieve high-quality upsampling results.

At the input stage, for luma processing, the neural network can receive multiple inputs including low-resolution luma reconstruction samples

$$( {Y}_{lr}^{rec} ) ,$$

low-resolution luma prediction samples

$$( {Y}_{lr}^{pred} ) ,$$

base quantization parameter (QP), slice QP, and slice type information. These inputs may be transferred from the video codec to the shared memory, where they can be accessed by the hardware accelerator for neural network computation.

At initial processing blocks, the luma input

$${Y}_{lr}^{rec}$$

may first pass through a convolutional block, which can extract initial feature representations from the low-resolution luma samples. The block may be followed by a Parametric Rectified Linear Unit (PReLU) activation function to introduce non-linearity while allowing for learnable parameters.

At the residual processing stage, the processed features can then flow through N ResBlocks, where N may be determined based on complexity requirements and performance constraints. Each ResBlock may comprise multiple convolutional layers with skip connections, enabling the network to learn complex scaling relationships while maintaining gradient flow during training. The ResBlocks can progressively refine the feature representations and may help the network learn hierarchical feature patterns for effective upsampling.

At the combination stage, features from

$${Y}_{lr}^{pred}$$

may be processed through a similar convolutional block with PReLU activation. These processed prediction features can then be combined with the residual block outputs with an addition operation (indicated by the “C” symbol), in order for the network to leverage both reconstruction and prediction information for improved scaling quality.

The final processing stage includes a convolutional block followed by a pixel shuffle operation. The pixel shuffle block can rearrange the processed feature maps to generate the high-resolution output

$${Y}_{hr}^{rec} .$$

This operation may efficiently convert the deep feature representations into properly scaled pixel values while maintaining spatial relationships.

For chroma processing, the neural network architecture can be similar to the luma pathway but may include additional inputs such as collocated luma information

$$( {Y}_{lr}^{rec} or {Y}_{hr}^{rec} )$$

to leverage cross-component correlation for improved chroma upsampling quality. The chroma pathway may also receive base QP, slice QP, and slice type information as metadata to guide the processing decisions.

The base QP and slice QP inputs can provide quantization-aware processing, allowing the neural network to adapt its scaling behavior based on the quality level of the input content. This metadata integration may help the network make more informed decisions about how aggressively to enhance details during upsampling.

Each ResBlock may comprise multiple convolutional layers with PReLU activations and skip connections. The skip connections can allow the network to learn residual mappings, which may be easier to optimize than learning the complete transformation. This design can help prevent gradient vanishing problems during training and may enable the network to achieve better scaling performance.

The shared memory architecture can enable efficient data exchange between the video codec and the hardware accelerator. Input data including reconstruction samples, prediction samples, and metadata may be stored in the shared memory, allowing the hardware accelerator to access this information without requiring transfers through external DRAM. Similarly, the processed output from the neural network can be written back to the shared memory for retrieval by the video codec.

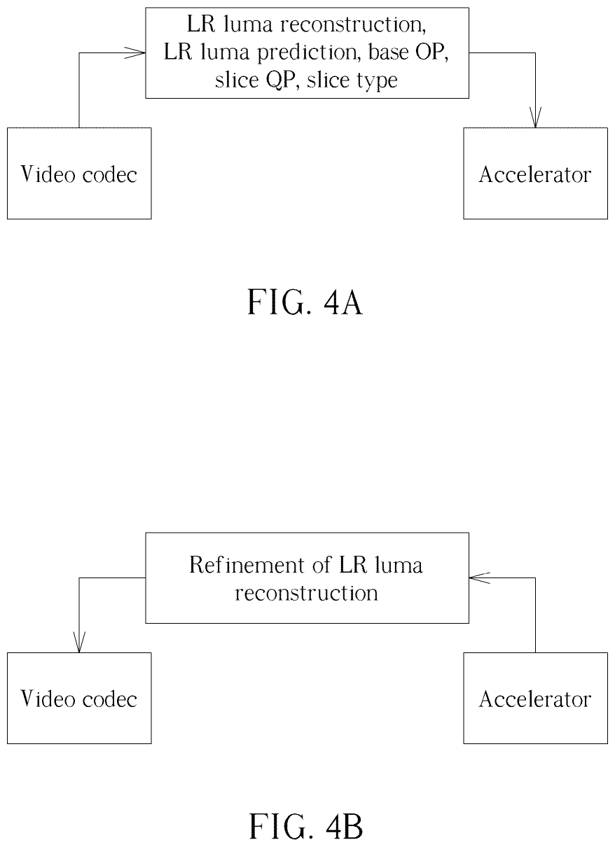

FIGS. 4A and 4B depict two sequential time instances of data exchange between a video codec and hardware accelerator for neural network-based reference picture resampling according to an embodiment. FIG. 4A depicts the first time instance where input data flows from the video codec to the hardware accelerator for neural network processing. During this phase, the video codec may transfer a comprehensive set of input parameters through the shared memory to the hardware accelerator. The data transfer includes low-resolution (LR) luma reconstruction samples, LR luma prediction samples, base quantization parameter (QP), slice QP, and slice type information.

The LR luma reconstruction samples can represent the reconstructed pixel values at reduced resolution that may serve as the primary input for the neural network upsampling process. These samples may contain the actual pixel content that needs to be enhanced to higher resolution. The LR luma prediction samples can provide additional context information that may help the neural network make more informed scaling decisions by understanding the prediction characteristics of the content.

The base QP and slice QP parameters can provide quantization-aware information that may allow the neural network to adapt its processing based on the quality level of the input content. Different QP values may indicate different levels of compression artifacts or quality degradation, which the neural network can take into account during the upsampling process. The slice type information can indicate whether the current slice is an I-slice, P-slice, or B-slice, which may influence the scaling approach since different slice types have different prediction characteristics.

This comprehensive data package can be stored in the shared memory where it becomes accessible to the hardware accelerator without requiring external DRAM access. The shared memory architecture may eliminate the latency and energy overhead that would otherwise be associated with transferring this data through external memory interfaces.

FIG. 4B depicts the second time instance where the processed results flow from the hardware accelerator back to the video codec. During this phase, the hardware accelerator may have completed its neural network computation and generated refined output data that can be transferred back through the shared memory to the video codec.

The output data includes Refinement of LR luma reconstruction, which can represent the enhanced pixel data produced by the neural network processing. This refined data may include improved spatial resolution and enhanced detail compared to the original LR input. The neural network may have applied learned transformations to upscale the input content while adding fine details and reducing artifacts that might be present in traditional interpolation-based scaling methods.

The refinement data can be stored in the shared memory, making it immediately accessible to the video codec for incorporation into the encoding or decoding process. The video codec may then use this refined data as enhanced reference samples for motion compensation or other video coding operations.

The sequential nature of FIGS. 4A and 4B illustrates that the data exchange can be a two-phase process with distinct input and output stages. The temporal separation may allow for efficient resource utilization where the video codec can continue with other processing tasks while the hardware accelerator performs the neural network computation. The shared memory can serve as an efficient buffer that facilitates this asynchronous processing model.

The data flow shown in these figures can be representative of similar exchanges that may occur for chroma processing, where additional inputs such as collocated luma information might also be transferred through the shared memory architecture. The same efficient exchange mechanism can be applied to various types of neural network-based video processing operations beyond RPR, including loop filtering, motion estimation, adaptive loop filtering, and other AI-assisted video coding tools.

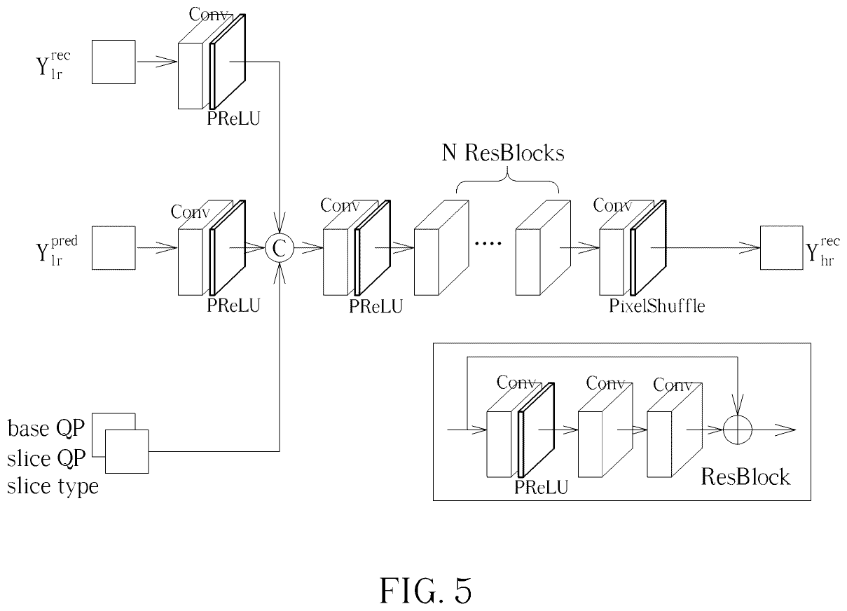

FIG. 5 depicts the architecture of a neural network-based super-resolution system that directly generates high-resolution reconstruction according to an embodiment, which is an alternative approach to the refinement-based method shown in FIG. 3. In the architecture of FIG. 5, the neural network can produce the final high-resolution output directly rather than generating refinements to traditionally upsampled images.

At the input processing stage, the neural network receives multiple input streams that can be processed through the shared memory interface. The primary inputs include low-resolution luma reconstruction samples

$$( {Y}_{lr}^{rec} ) ,$$

low-resolution luma prediction samples

$$( {Y}_{lr}^{pred} ) ,$$

and slice type information, along with quantization parameters (base QP and slice QP) that provide quality-aware context information.

The

$${Y}_{lr}^{rec}$$

input may be processed through an initial convolutional block followed by a PReLU activation function. This initial processing stage can extract fundamental feature representations from the reconstructed low-resolution samples. Similarly, the

$${Y}_{lr}^{pred}$$

input may undergo processing through a corresponding convolutional block with PReLU activation, allowing the network to capture prediction-related characteristics that can inform the upsampling process.

During feature combination and processing, the processed features from both reconstruction and prediction inputs can be combined through an addition operation (indicated by the “C” symbol), enabling the neural network to leverage information from both sources. The combination may allow the network to understand both the actual reconstructed content and the prediction patterns, which can lead to more informed scaling decisions.

The combined features may then flow through a convolutional block with PRELU activation, which can perform spatial filtering and feature refinement. This intermediate processing stage may help the network adapt the combined feature representations for optimal processing by the subsequent residual blocks.

During residual block processing the neural network includes N ResBlocks, where N can be configured based on computational constraints and quality requirements. Each ResBlock, as detailed in the expanded view, may comprise three sequential convolutional layers, each followed by PReLU activation functions. The ResBlock architecture can include skip connections that allow the network to learn residual mappings, which may be easier to optimize and can help prevent gradient vanishing during training.

The multiple ResBlocks can enable the network to progressively refine the feature representations through hierarchical processing. Each ResBlock may capture different levels of spatial and temporal correlations, allowing the network to model complex scaling relationships while maintaining computational efficiency.

Following the ResBlock processing, the features may pass through a final convolutional block that prepares the data for the pixel shuffle operation. The pixel shuffle block can rearrange the processed feature maps to generate the high-resolution output

$${Y}_{hr}^{rec}$$

directly, without requiring traditional upsampling as an intermediate step.

The direct generation approach can eliminate the need for the

$${Y}_{hr}^{rpr}$$

intermediate output that would typically be produced by conventional spatial filtering methods. By bypassing traditional interpolation, the neural network may achieve superior scaling quality while reducing computational overhead associated with multi-stage processing.

The base QP and slice QP parameters can provide quantization-aware information that may allow the neural network to adapt its processing based on the quality level of the input content. Different QP values may indicate different levels of compression artifacts or quality degradation, which the neural network can take into account during the upsampling process. The slice type information can indicate whether the current slice is an I-slice, P-slice, or B-slice, which may influence the scaling approach since different slice types have different prediction characteristics.

For upsampling chroma components, the neural network can also be utilized to generate high-resolution chroma components directly. However, additional inputs such as luma reconstruction data may be required for hardware accelerator computation. These supplementary inputs can leverage cross-component correlation and temporal characteristics to improve chroma upsampling quality, and may be efficiently transferred through the shared memory interface along with the primary chroma data.

In certain embodiments, the neural network can be trained to reduce coding artifacts present in reconstructed video content. The neural network may function as an in-loop filter or post-loop filter to refine the reconstructed pictures for enhanced visual quality. The artifact reduction filter can also be executed by the hardware accelerator, taking advantage of the neural network's ability to learn complex artifact patterns and apply sophisticated enhancement algorithms. With the shared memory architecture, the efficiency of data exchange between the video codec and hardware accelerator can be significantly improved.

The neural network shown in FIG. 5 can be particularly effective for applications where the shared memory interface enables efficient data exchange between the video codec and hardware accelerator. Input data including reconstruction samples, prediction samples, and metadata may be transferred through the shared memory, allowing the hardware accelerator to perform the neural network computation without requiring external DRAM access. The resulting high-resolution output can be written back to the shared memory for immediate access by the video codec.

2. Data Exchange from Video Codec to Accelerator with CIM

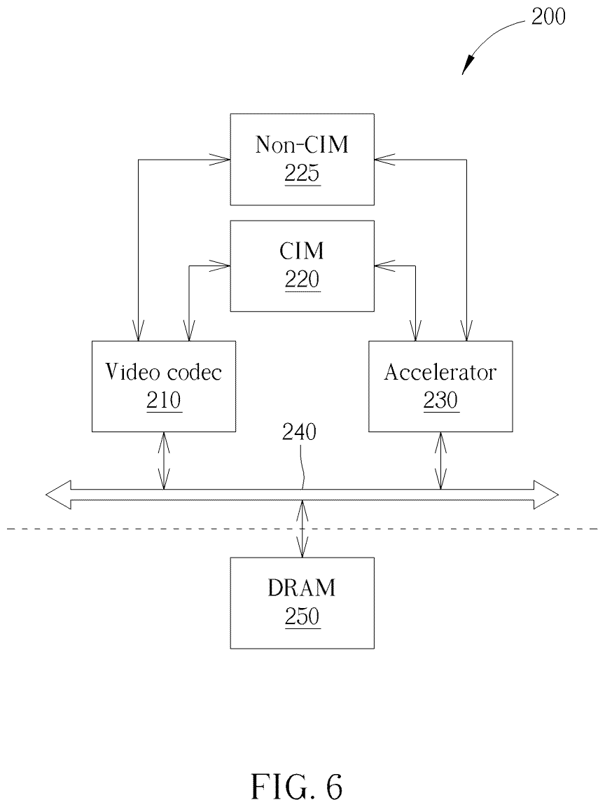

FIG. 6 depicts a block diagram of an exemplary apparatus 200 for video coding according to an embodiment. The apparatus 200 comprises a video codec 210, a dual-channel shared memory system with CIM (Compute-In-Memory) channel (CIM shared memory) 220 and non-CIM channel (non-CIM shared memory) 225, and a hardware accelerator 230, all integrated on-chip and coupled to external DRAM 250 via an on-chip bus 240.

The video codec 210 is arranged to process video data for encoding or decoding operations and has bidirectional access to both the CIM channel 220 and the non-CIM channel 225 of the shared memory system. The video codec 210 can route different types of data to appropriate memory channels based on the processing requirements. For data that requires computational preprocessing or post-processing, the video codec 210 may direct the information to the CIM channel 220. For metadata, control information, or data that does not require in-memory processing, the video codec 210 may utilize the non-CIM channel 225.

The CIM channel 220 is a compute-in-memory section that can perform computational operations on data stored in the memory. The CIM channel 220 may be equipped with processing capabilities that enable various operations including batch normalization, pooling, down-sampling, data format conversion, and pixel shuffling. The CIM functionality can significantly reduce the computational burden on both the video codec 210 and hardware accelerator 230 by performing preprocessing and post-processing operations directly within the memory interface.

Unlike conventional memory systems that serve purely as passive storage elements, the CIM channel 220 incorporates specialized computational circuitry and processing logic directly within the memory structure, so as to enable data processing operations to occur at the location where data resides rather than requiring data movement to separate processing units. The compute-in-memory paradigm leverages the principle of near-data computing, where arithmetic and logical operations are performed in close proximity to the stored data, thereby eliminating the energy and latency overhead associated with data movement between memory and processing units. This approach can provide significant advantages in terms of energy efficiency, as data movement typically consumes substantially more power than the actual computational operations, particularly in modern semiconductor processes where wire delays and capacitive loads dominate power consumption. Furthermore, the CIM architecture can provide enhanced system throughput by enabling concurrent operations where memory access and computation can proceed simultaneously rather than sequentially.

For data transferring from the video codec 210 to the hardware accelerator 230, the CIM channel 220 may perform critical preprocessing operations. Batch normalization can be done by the CIM channel 220 as a common preprocessing step for neural network computation. The process may convert pixel samples to proper numerical formats and ranges that are optimal for the hardware accelerator 230 to process, ensuring that input data maintains appropriate statistical properties for effective neural network inference. Additionally, pooling/down-sampling done by the CIM channel 220 can perform pooling and down-sampling operations that may be required by specific deep neural network architectures. These operations can reduce spatial dimensions of input data, extract salient features, or prepare data in formats expected by subsequent processing stages in the hardware accelerator 230.

For data transferring from the hardware accelerator 230 back to the video codec 210, the CIM channel 220 may perform post-processing operations such as data format conversion, converting from accelerator native data types (e.g., 32-bit/16-bit integer or floating-point) to video codec formats (e.g., 8-bit/10-bit/12-bit YCbCr/RGB). The CIM channel 220 may also handle pixel shuffling operations, rearranging processed feature maps for super-resolution applications, and quantization operations, applying shift and rounding operations for format conversion.

The non-CIM channel 225 functions as conventional shared memory for data that does not require computational processing and serves as an additional channel to send metadata to guide the pre-processing operations. The non-CIM channel 225 may be optimized for efficient storage and retrieval of metadata, control parameters, and other information that supplements the main video processing data. The non-CIM channel 225 can handle metadata exchange including QP values, slice types, temporal layer information, and other coding parameters that can guide the CIM preprocessing operations. It may also manage control information such as processing mode selections, neural network configuration parameters, and algorithm selection data.

The additional channel to send metadata to guide the pre-processing functionality ensures that the CIM channel 220 receives appropriate context information to make informed decisions about batch normalization parameters, pooling strategies, and other preprocessing operations. This preprocessing guidance may include statistics-based information derived from QP, TID, slice type and/or other parameters that can inform and optimize the computational operations performed in the CIM channel 220. The metadata can be much smaller in volume compared to the pixel data but provides essential guidance for optimizing the computational efficiency and quality of the CIM preprocessing operations.

The hardware accelerator 230 may comprise one or more specialized processing units such as NPU, GPU, AI core, DPU, CPU, or APU. The accelerator 230 has bidirectional access to both memory channels, allowing it to receive preprocessed data from the CIM channel 220 and access metadata from the non-CIM channel 225. This dual-channel access can enable the accelerator 230 to focus its computational resources on core processing tasks while benefiting from the preprocessing performed by the CIM capabilities. The separation of CIM channel 220 and non-CIM channel 225 can optimize system efficiency by ensuring that computational resources are allocated only where needed, while conventional memory operations can proceed with minimal overhead. The metadata guidance provided through the non-CIM channel ensures that the CIM channel preprocessing operations are optimally configured for the specific content and coding conditions.

### 3. Reuse CIM for Offloading Computation of Video Codec

The CIM capabilities of the shared memory architecture can be utilized to offload certain computational operations from the video codec, providing enhanced system efficiency and performance benefits. By performing specific video coding operations directly within the memory interface, the CIM functionality can reduce the processing burden on the main video codec pipeline while maintaining high-quality results. This approach may enable more efficient resource utilization and improved overall system performance for video encoding and decoding applications.

For video codec implementations, loop filtering is an important processing stage that contributes significantly to both coding efficiency and subjective visual quality of reconstructed video content. In H.266/VVC standard implementations, deblocking filter and ALF (adaptive loop filter) are commonly employed as key stages in the loop filtering pipeline. While deblocking filter operations typically require detection of block boundaries for targeted filtering, ALF applies filtering operations on a sample-by-sample basis across the entire picture.

The ALF operation can be characterized as a convolution computation, making it particularly suitable for implementation using CIM capabilities. The CIM channel may be configured to perform ALF operations by loading ALF coefficients as computational weights within the memory structure. The convolution operation between ALF coefficients and pixel data stored in the CIM memory can be executed directly within the memory interface, effectively offloading this computational burden from the main video codec processing pipeline. The ALF coefficients may be dynamically loaded based on the specific filtering requirements, allowing the CIM to adapt to different content characteristics and quality targets. The filtered pixel data can then be made available to the video codec through the shared memory interface without requiring additional external memory transactions.

In addition to loop filtering, CIM capabilities can be effectively utilized to assist in motion estimation operations, which represent computationally intensive components of video encoding processes. Motion estimation typically involves searching for optimal motion vectors by comparing current blocks with reference areas across multiple candidate positions. The CIM architecture can support motion estimation through two distinct operational scenarios that leverage the in-memory computing capabilities.

One implementation involves CIM-assisted motion estimation where the CIM performs several fundamental mathematical operations required for motion vector search. The CIM can execute subtraction operations, computing differences between current blocks (denoted as C) and reference blocks (denoted as R) to generate residual data. Following the subtraction operations, the CIM may perform multiplication operations, calculating squared differences (C−R)×(C−R) to generate cost metrics for each comparison. The CIM can then apply pooling operations to identify minimum cost values across different patches or sub-patches within the search area. The CIM assistance enables the identification of patches or sub-patches with the lowest motion estimation costs, which can serve as candidates for more detailed motion vector search operations. The main motion search engine of the codec can then focus its computational resources on these promising candidates rather than performing exhaustive search across the entire search area.

In more detail, the CIM-assisted motion estimation process can be implemented through a systematic sequence of mathematical operations. Initially, the CIM performs subtraction operations between current block samples (C) and reference block samples (R), generating difference values (C−R) that represent the residual information between the blocks being compared. Subsequently, the CIM executes multiplication operations on these difference values, thereby computing squared differences (C−R)×(C−R) to generate cost metrics that quantify the similarity between current and reference blocks. Following the computation of squared differences, the CIM applies pooling operations to identify optimal motion vector candidates across the search area. The pooling stage can be implemented using one of two approaches depending on the specific system requirements. The first approach employs minimal pooling across patches or sub-patches, where the CIM identifies the smallest cost values among the computed squared differences to locate the best matching regions. Alternatively, the second approach utilizes maximal pooling with negated input values, where the squared differences are first negated to −(C−R)×(C−R) before applying maximum pooling operations to achieve equivalent results through inverted comparison logic. Either minimal pooling or maximal pooling with negated input can be selected based on the hardware implementation preferences and computational efficiency considerations. Both approaches ultimately identify the patches or sub-patches that provide the lowest motion estimation costs, enabling the subsequent motion search engine to focus on these promising candidates for detailed motion vector determination.

Another implementation involves enhanced CIM capabilities that can output motion vectors directly. In this implementation, the CIM maintains additional information about pixel locations within patches that generate the lowest cost values during pooling operations. The location tracking requires additional storage capacity within the CIM structure but enables the generation of motion vector candidates directly from the memory interface. The motion vector derivation process can utilize both patch coordinate information and the specific pixel locations that produced optimal costs. If the tracked pixel location information is maintained in global coordinate system, the CIM can output this location directly as a motion vector candidate. Alternatively, if the pixel location is stored in patch-relative coordinates, the CIM can combine the patch global coordinates with the relative pixel location to generate the final motion vector.

CIM-derived motion vectors may be used directly for video coding operations if their precision meets the requirements, or they can serve as starting points for additional motion vector refinement processes. Dedicated hardware refinement mechanisms or software-based refinement algorithms can be applied to achieve sub-pixel or quarter-pixel motion vector precision when required. This approach can provide significant computational savings compared to traditional motion estimation methods while maintaining or potentially improving motion vector quality through the parallel processing capabilities of the CIM architecture.

4. Data Exchange from Accelerators to Video Codec

The shared memory architecture with CIM capabilities can support bidirectional data flow, including scenarios where data traffic is initiated from hardware accelerators and subsequently processed through the CIM before being delivered to the video codec. This reverse data flow pattern enables the CIM to perform various post-processing tasks that can enhance the efficiency and quality of data exchange from accelerators back to the video codec. The CIM capabilities in this configuration can handle specialized operations that bridge the gap between accelerator output formats and video codec input requirements, ensuring seamless integration while optimizing computational efficiency.

The post-processing functionality provided by the CIM can address several critical aspects of accelerator-to-codec data exchange, including format conversion, algorithmic operations, and data reorganization tasks. By performing these operations within the memory interface, the system can reduce the computational burden on both the hardware accelerator and the video codec while maintaining high-quality data processing. The following subsections provide detailed descriptions of the specific post-processing capabilities that can be implemented through the CIM architecture.

The CIM capabilities can be effectively utilized to perform data format conversion operations that are essential for proper integration between hardware accelerators and video codecs. Hardware accelerators, particularly neural processing units and specialized AI cores, typically generate output data in native formats that are optimized for their internal processing architectures. These native data formats may include 16-bit integer, 32-bit integer, or various floating-point data types that provide the precision and dynamic range required for neural network computations and other accelerator operations.

Video codec implementations are designed to process pixel data using specific integer formats that align with video coding standards and display requirements. Video codecs typically handle pixel information as non-byte-aligned integer data with bit depths such as 8-bit, 10-bit, or 12-bit for YCbCr or RGB color spaces. The fundamental difference in data representation requires a format conversion that needs to be addressed to enable effective data exchange between accelerators and video codecs.

The CIM can be equipped with data format conversion capabilities that can handle the transformation from hardware accelerator native formats to video codec compatible formats. These conversion operations can be implemented through specialized computational functions embedded within the CIM structure. For example, shift operations can be applied to adjust the bit precision and dynamic range of the data, ensuring that the numerical values are properly scaled for video codec processing. Additionally, rounding operations can be incorporated to manage precision reduction when converting from higher-precision accelerator formats to lower-precision video codec formats.

The shift and rounding operations can be configured dynamically based on the specific requirements of the video coding operation and the characteristics of the accelerator output data. The flexibility enables the CIM to handle various conversion scenarios while maintaining optimal quality and computational efficiency. The format conversion process can be executed concurrently with data storage operations, reducing the latency that would be associated with separate conversion steps.

The CIM can provide significant benefits by offloading specific algorithmic operations from hardware accelerators, particularly those that involve data reorganization and final processing stages of neural network-based algorithms. Many advanced video processing algorithms, especially neural network-based super-resolution techniques, conclude with specialized operations that prepare the processed feature data for integration with video codec operations.

Pixel shuffling is an important part of many neural network-based super-resolution algorithms, where processed feature maps are rearranged to generate properly structured pixel data. The pixel shuffling process typically involves reorganizing multi-channel feature data into spatial pixel arrangements that correspond to higher resolution image structures. This operation can be computationally intensive and may require significant memory bandwidth when performed by traditional processing units.

The CIM can be configured to execute pixel shuffling operations efficiently by leveraging its integrated computational and memory capabilities. The CIM can access the feature map data directly from its memory storage and apply the necessary rearrangement operations to generate the final pixel output. This approach can eliminate the need for additional data transfers and reduce the computational load on the hardware accelerator, allowing it to focus on the core neural network inference operations.

Additionally, the CIM can perform convolution operations that may be required in the final stages of super-resolution algorithms. Some neural network architectures employ convolution operations as the concluding step to refine the shuffled pixel data and generate the final high-resolution output. The CIM can execute these convolution operations using stored kernel weights and apply them to the pixel data to produce the final processed results.

### 5. Method of Video Coding

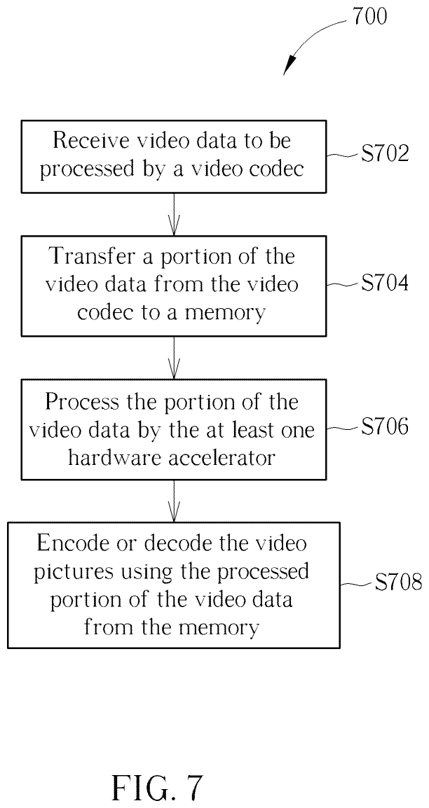

FIG. 7 depicts a flow diagram showing a method 700 for encoding or decoding video pictures. The method 700 includes the following steps:
S702: Receive video data to be processed by a video codec;
S704: Transfer a portion of the video data from the video codec to a memory;
S706: Process the portion of the video data by the at least one hardware accelerator; and
S708: Encode or decode the video pictures using the processed portion of the video data from the memory.

In step S702, this step involves the video codec receiving video data that requires processing for either encoding or decoding operations. For encoding scenarios, the received video data may comprise raw or uncompressed video frames or associated pixel data that need to be compressed into a bitstream format suitable for storage or transmission. The input video data can include various color space representations such as YCbCr or RGB formats, and may support different bit depths including 8-bit, 10-bit, or 12-bit precision depending on the quality requirements and target applications. For decoding scenarios, the received video data may include compressed bitstream information that needs to be reconstructed into displayable video frames. The input data can include encoded syntax elements, quantized transform coefficients, motion vector information, and other compressed data components that are essential for the reconstruction process.

The video codec may parse and analyze this input data to determine the specific processing requirements and identify portions that can benefit from hardware accelerator enhancement. The video codec may also perform initial analysis of the received video data to determine optimal processing strategies, identify content characteristics that may influence accelerator utilization, and establish processing parameters such as quantization settings, prediction modes, and filtering requirements. This preliminary analysis can inform subsequent decisions about which portions of the video data should be directed to hardware accelerator processing and what specific operations should be performed.

In step S704, following the initial data reception and analysis, the video codec selectively transfers specific portions of the video data to the shared memory for further processing. The memory referenced in this step is accessible by both the video codec and the hardware accelerator, enabling efficient data exchange without requiring external memory transactions. The shared memory may incorporate CIM capabilities that can perform computational operations on the data during or after the transfer process.

The portion of video data selected for transfer may be determined based on various factors including the type of processing required, the availability of accelerator resources, and the potential benefits of accelerator-based processing for specific content characteristics. For reference picture resampling applications, the transferred data may include low-resolution reconstruction samples, prediction samples, quantization parameters, and metadata such as slice type information. For loop filtering operations, the transferred data may comprise reconstructed pixel samples and associated filter coefficients.

The transfer process can be optimized to minimize latency and energy consumption by utilizing the on-chip shared memory architecture. The video codec may organize the data transfer to align with the processing capabilities of the hardware accelerator and any CIM preprocessing requirements. If the shared memory includes CIM channels, the video codec may route computationally intensive data through the CIM channel while directing metadata and control information through non-CIM channels.

The timing of the data transfer can be coordinated with the overall video processing pipeline to ensure that accelerator processing does not introduce bottlenecks or delays in the encoding or decoding operations. The video codec may implement buffering strategies that allow for asynchronous processing, enabling the accelerator to operate on transferred data while the codec continues with other processing tasks.

In step S706, once the video data has been transferred to the shared memory, the hardware accelerator performs specialized processing operations on the data to enhance quality, improve efficiency, or implement advanced algorithms that exceed the capabilities of traditional video codec implementations. The hardware accelerator may comprise various types of processing units including neural processing units (NPU), graphics processing units (GPU), AI cores, deep learning processing units (DPU), central processing units (CPU), or accelerated processing units (APU).

For neural network-based processing, the hardware accelerator may implement sophisticated algorithms such as super-resolution enhancement, artifact reduction, or advanced prediction techniques. The accelerator can access the transferred data from the shared memory and apply trained neural network models to generate enhanced output. The processing may involve multiple stages including feature extraction, hierarchical processing through residual blocks, and output generation through pixel shuffling or other specialized operations.

For reference picture resampling applications, the hardware accelerator may perform neural network-based scaling operations that provide superior quality compared to traditional interpolation methods. The accelerator can process low-resolution input data along with associated metadata to generate high-resolution output with enhanced detail preservation and artifact reduction. The neural network processing may be guided by quantization parameters and content characteristics to adapt the enhancement strategy to specific video content.

The hardware accelerator may also perform loop filtering operations, motion estimation assistance, or other video coding enhancements that leverage specialized computational capabilities. For loop filtering, the accelerator can apply adaptive filtering algorithms that are more sophisticated than traditional linear filters. For motion estimation, the accelerator may perform parallel search operations or apply machine learning-based motion prediction techniques.

If the shared memory includes CIM capabilities, some preprocessing or post-processing operations may be performed directly within the memory interface, reducing the computational burden on the hardware accelerator. The CIM may handle operations such as batch normalization, data format conversion, or intermediate filtering operations, allowing the accelerator to focus on core algorithmic processing.

In step S708, this step involves the video codec retrieving the processed data from the shared memory and incorporating it into the encoding or decoding pipeline to generate the final video output. The processed data may include enhanced pixel samples, refined prediction information, improved reference pictures, or filtered reconstruction data, depending on the specific processing operations performed by the hardware accelerator.

For encoding applications, the video codec may use the processed data to improve prediction accuracy, enhance reference picture quality, or apply advanced filtering techniques that result in improved coding efficiency. The enhanced data can lead to better compression ratios, reduced bitrate requirements, or improved visual quality at equivalent bitrates. The codec may integrate the processed data into various stages of the encoding pipeline including prediction, transformation, quantization, and entropy coding operations.

For decoding applications, the video codec may utilize the processed data to improve reconstruction quality, reduce artifacts, or enhance the visual appearance of the decoded video content. The accelerator-processed data can provide superior quality compared to traditional decoding methods, particularly for challenging content or low-bitrate scenarios where artifacts may be more prominent.

The integration of processed data may require format conversion or data reorganization to ensure compatibility with the video codec's internal data structures and processing requirements. If the shared memory includes CIM capabilities, some of these conversion operations may be performed within the memory interface to streamline the integration process.

The video codec may also implement quality control and validation procedures to ensure that the accelerator-processed data meets the required quality standards and maintains compatibility with video coding standards. The encoding or decoding output represents the combined result of traditional video codec processing enhanced by specialized hardware accelerator capabilities, providing improved performance and quality compared to conventional video coding implementations.

### 6. Additional Note

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from +20% in broader applications to progressively tighter tolerances of +10%, +5%, +3%, +2%, +1%, or +0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of video coding for encoding or decoding video pictures, comprising:
receiving video data to be processed by a video codec;
transferring a portion of the video data from the video codec to a memory, wherein the memory is accessible by both the video codec and at least one hardware accelerator;
processing the portion of the video data by the at least one hardware accelerator to generate a processed portion of the video data;
encoding or decoding the video pictures using the processed portion of the video data from the memory.

2. The method of claim 1, wherein the processing comprises at least one of: reference picture resampling, loop filtering, motion estimation, or adaptive loop filtering.

3. The method of claim 2, wherein the reference picture resampling comprises neural network-based scaling operations for generating upsampled or downsampled reference pictures.

4. The method of claim 2, wherein the adaptive loop filtering is performed using convolution operations between filter coefficients and pixel data stored in the memory.

5. The method of claim 1, wherein the at least one hardware accelerator comprises at least one of: a neural processing unit (NPU), a graphics processing unit (GPU), an artificial intelligence (AI) core, a central processing unit (CPU), or a deep learning processing unit (DPU).

6. The method of claim 1, wherein the memory comprises compute-in-memory (CIM) capabilities for performing one or more computational operations on the portion of the video data.

7. The method of claim 6, wherein the one or more computational operations comprise at least one of: batch normalization, pooling, down-sampling, data format conversion, or pixel shuffling.

8. The method of claim 6, wherein the CIM capabilities perform motion estimation by executing subtraction operations, multiplication operations, and pooling operations to determine motion vectors.

9. The method of claim 6, wherein the memory comprises both CIM channels and non-CIM channels.

10. The method of claim 1, wherein the processed portion of the video data comprises at least one of the following to be transferred back to the video codec through the memory: luma reconstruction data, chroma reconstruction data, or filtered pixel data.

11. An apparatus for video coding, comprising:
a video codec configured to receive the video data and to transfer a portion of the video data;
a memory accessible by the video codec, configured to receive and store the portion of the video data;
a hardware accelerator accessible to the memory, configured to process the portion of the video data to generate a processed portion of the video data; and
wherein the video codec is further configured to encode or decode the video pictures with the processed portion of the video data.

12. The apparatus of claim 11, wherein the hardware accelerator is configured to perform at least one of: reference picture resampling, loop filtering, motion estimation, or adaptive loop filtering.

13. The apparatus of claim 12, wherein the hardware accelerator is configured to perform reference picture resampling using neural network-based scaling operations for generating upsampled or downsampled reference pictures.

14. The apparatus of claim 12, wherein the hardware accelerator is configured to perform adaptive loop filtering using convolution operations between filter coefficients and pixel data stored in the memory.

15. The apparatus of claim 11, wherein the hardware accelerator comprises at least one of: a neural processing unit (NPU), a graphics processing unit (GPU), an artificial intelligence (AI) core, a central processing unit (CPU), or a deep learning processing unit (DPU).

16. The apparatus of claim 11, wherein the memory comprises compute-in-memory (CIM) capabilities configured to perform one or more computational operations on the portion of the video data.

17. The apparatus of claim 16, wherein the CIM capabilities are configured to perform at least one of: batch normalization, pooling, down-sampling, data format conversion, or pixel shuffling.

18. The apparatus of claim 16, wherein the CIM capabilities are configured to perform motion estimation by executing subtraction operations, multiplication operations, and pooling operations to determine motion vectors.

19. The apparatus of claim 16, wherein the memory comprises both CIM channels and non-CIM channels.

20. The apparatus of claim 11, wherein the processed portion of the video data comprises at least one of the following to be transferred back to the video codec through the memory: luma reconstruction data, chroma reconstruction data, or filtered pixel data.
